(19) United States
(12) Patent Application Publication
(10) Pub. No.: US 2006/0062639 A1
(43) Pub. Date: Mar. 23, 2006

(54) Device for suctioning a powdery product

(76) Inventors: Yves Dietrich, Chevilly (CH); Frederic Dietrich, Morrens (CH)

Correspondence Address: CASELLA & HESPOS, 274 MADISON AVENUE, NEW YORK, NY, 10016, US

(21) Appl. No.: 10/528,192

(22) PCT Filed: Sep. 25, 2002
(86) PCT No.: PCT/IB02/03962

§ 371 Date: Mar. 17, 2005

(51) Int. Cl. B65G 53/16

(52) U.S. Cl. 406/86

(57) ABSTRACT

The invention relates to a device for suctioning a powdery product. Said device comprises a auctioning tube (1,1′) which can be connected to a pneumatic suction transfer system and a clod-breaking device comprising a worm conveyor (4) which is rotationally driven by a motor (10) via a shaft (7). The worm conveyor is located at the end of the auctioning device in a truncated housing (3). The blades of the worm conveyor are provided with teeth and the shaft (7) is provided with knives (8) downstream from the worm conveyor (4). Any clods can be broken up by the worm conveyor (4) and the knives (8) complete the work of the worm conveyor by breaking up any clusters which move beyond the worm conveyor (4).

The present invention concerns a device for suctioning a powdery product from a reservoir, comprising a suction pipe connected to a pneumatic suction transfer installation, said pipe including a tube designed to be connected at one of its ends to a suction transfer hose.

In the pharmaceutical and fine chemical industries, powdery raw materials, intermediates and finished products are often stored in drums. Certain products have the tendency to form lumps or to compact when they are stored for long periods or when they are transported. Agglomerates can also form during a production stage (drying, centrifuging, etc.)

A drum is a simple and economical means for storing and transporting powder. These drums must however be emptied at one time or another and the powder will be either packaged or used for a new production stage.

In most processes, (packaging, reacting, mixing, etc.) the powder must be ground or sieved before being used.

Two methods exist for emptying drums containing powder, either by gravity, by turning the drum upside down, or by suction using a pneumatic powder transfer system.

The most usual method is to empty the drum manually. The drum is raised and emptied into a sieve or grinder. This method however generates a lot of dust. The drum has to be handled manually or costly and bulky handling equipment has to be used for turning the drums upside down. The product is, in most cases, put back into the drum and will once again will be emptied out during the following production stage or even in certain cases will be suctioned directly by a pneumatic conveyer system.

It is practically impossible or particularly difficult to transfer powder directly from the drum by a pneumatic system when it contains lumps or when the product is highly compacted in the drum.

Mechanical installations exist that can grind the product directly in the drum thus making it possible to suction the product after preparation. These installations are however costly and are often not designed for pharmaceutical applications. The powder is more frequently stored in plastic sacks that must not be damaged during various handling operations.

The object of the present invention it to provide a device overcoming the aforementioned disadvantages.

The device according to the invention is characterized in that the second end of the tube is provided with a lump-breaking head arranged so as to break down lumps and to enable the product to be suctioned.

The advantage of the device according to the invention is that it is a relatively light device that is therefore maneuverable and has a cost that is affordable compared with a conventional grinding installation. The device makes it possible to suction the powder directly from a reservoir while breaking up the lumps during suctioning. The mechanical force on the powder is further limited since the powder is suctioned as soon as it is broken down and in this way its structure is not modified.

According to a preferred embodiment, the head includes a propeller formed of at least two blades with teeth, integral with a shaft driven by a pneumatic motor, and the blades present an angle of incidence that enables the product to be driven in the direction of suctioning.

According to one embodiment, the shaft is provided with radial knives close to the lump-breaking head. Thus, if agglomerates of the product pass through the blades of the propeller they will be broken down by the knives preventing the product from compacting in the suction pipe.

According to another alternative embodiment, the lower end of the head is provided with protective bars preventing direct contact between said head and the reservoir. These bars are particularly useful when the reservoirs are drums containing plastic sacks since they limit or even eliminate the risk of damaging these.

According to a preferred embodiment, the device is provided with a handle in the form of a loop surrounding the pipe on its upper part, said loop being provided with a device for controlling the pneumatic motor.

Finally, the lump-breaking head may be detachable in order to adapt the device to the properties of the product to be transferred. This adaptation can relate equally well to the properties of the material used as to the mechanical properties of the head and more particularly the blades.

The invention will be described in greater detail with the aid of the accompanying drawings:

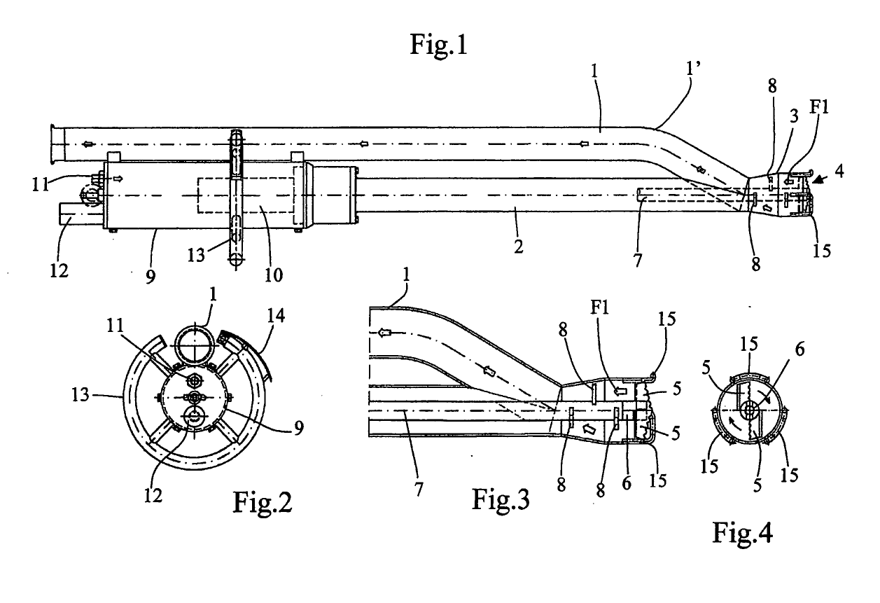

FIG. 1 is a side view of the suction pipe;

FIG. 2 is left hand view of FIG. 1;

FIG. 3 is an enlargement of the lower part of the suction pipe; and

FIG. 4 is a right hand view of FIG. 3.

The suction pipe comprises a suction tube 1 connected at its upper end by a rapid connection to a hose (not shown) of a pneumatic installation for transferring powdery products by suction. The lower end of the tube 1 has an elbow 1′ connected to a tube 2 shielding a shaft 7 driven by a pneumatic motor 10 housed in a protective casing 9. The motor 10 is supplied with compressed air through an inlet 11 and the air escapes through an outlet 12 situated on the upper part of the casing 9 so as to prevent any contamination with the product to be transferred. The lower part of the tube 2 emerges in a tapered head 3 ending in a cylindrical part. A propeller 4 having at least two blades 5 with teeth integral with a spindle 6 is coupled onto the end of the shaft 7. The blades present an angle of incidence that enables the product to be driven in the direction of suction (arrows F1). The lower part of the shaft 7 is provided with radial knives 8 for breaking down any agglomerates of the product that may not have been broken down by the blades 5, in this way preventing the product from compacting in the tube 1 and its elbow 1′. Three bars 15 prevent the head, 3 and more precisely the propeller 4, from contacting the drum to be emptied. These bars are particularly useful when the product is situated in a plastic sack that could be damaged by direct contact with the propeller 4.

The upper part of the device is provided with a handle 13 in the form of a loop enabling it to be handled. It is provided with a lever for controlling the motor 10. The lever 14 returns automatically to the stop position for the motor 10 as soon as it is released. The device can be suspended by a hook from a bracket with a weight compensator, making it easier to handle.

The propeller 4 is detachable so that the device can be adapted to the properties of the product. The angle of incidence of the propeller as well as the pitch of the teeth and their shape can be modified according to the product. For example, a more pronounced angle of incidence can be useful for products possessing good air permeability properties and will provide a good capacity for suctioning the powder. On the other hand, the angle of incidence should be reduced for a sticky or compacting product and the number of knives, in the rear part, should be increased so as to prevent compacting of the product in the suction head.

The device described, or lump-breaking pipe, is connected to a pneumatic suctioning conveyer installation. The operator introduces the pipe into the drum and, when the product is suctioned, he activates the motor 10 via the lever 14 so as to break up the agglomerates. When the drum has been emptied, he can stop the motor, suction the powder remaining at the bottom of the drum and therefore prevent damage to the sacks.

Combining the lump-breaking pipe with a pneumatic conveyer installation makes it possible to suction the product directly from the drum even if the product is compacted and lumpy. Any handling of the drum is eliminated in this way. The product can be directly transferred into the equipment to be loaded.

To summarize, the advantages of this device are as follows:
a reduction in the need to handle drums and associated equipment;
a simple, compact and economical device that can be easily transported and is silent;
different sizes of drums, with or without sacks, can be emptied;
only a small amount of dust is created and
the stress on the product is low so that the properties of the product are preserved.

The device can also be used by advantageously incorporating it in a pneumatic transfer line for powdery products. In this way, for example, having the device incorporated in the transfer tube close to the suction point or directly at the outlet from a storage hopper, makes it possible to dispense with the installation of a costly grinder in the lower part of a storage hopper or at the outlet from a drier, centrifuge, etc. In this case, the lever 14 is not necessary since the pipe is incorporated in the transfer line and the motor 10 is controlled synchronously with the suction.

1. A device for suctioning a powdery product from a reservoir, comprising a suction pipe connected to a pneumatic suction transfer installation, said pipe including a tube designed to be connected at one of its ends to a suction transfer hose, characterized in that the second end of the tube is provided with a lump-breaking head arranged so as to break down lumps and to enable the product to be suctioned.

2. The device as claimed in claim 1, characterized in that the head includes a propeller formed of at least two blades with teeth, integral with a shaft driven by a pneumatic motor, and that the blades present an angle of incidence that enables the product to be driven in the direction of suctioning.

3. The device as claimed in claim 2, characterized in that the shaft is provided with radial knives close to the lump-breaking head.

4. The device as claimed in claim 1, characterized in that the lower end of the head is provided with protective bars preventing direct contact between said head and the reservoir.

5. The device as claimed in claim 1, characterized in that it is provided with a handle in the form of a loop surrounding the pipe on its upper part, said loop being provided with a device for controlling the pneumatic motor.

6. The device as claimed in claim 1, characterized in that the lump-breaking head can be detached in order to adapt the device to the properties of the product to be transferred.

7. A use for the device as claimed in claim 1 in a line for the pneumatic transfer of powdery products, the device being incorporated in the transfer tube close to the suction point or directly at the outlet from a storage hopper.

8. A use for the device as claimed in claim 2 in a line for the pneumatic transfer of powdery products, the device being incorporated in the transfer tube close to the suction point or directly at the outlet from a storage hopper.

9. A use for the device as claimed in claim 3 in a line for the pneumatic transfer of powdery products, the device being incorporated in the transfer tube close to the suction point or directly at the outlet from a storage hopper.

10. The device as claimed in claim 2, characterized in that the lower end of the head is provided with protective bars preventing direct contact between said head and the reservoir.

11. The device as claimed in claim 3, characterized in that the lower end of the head is provided with protective bars preventing direct contact between said head and the reservoir.
